(19) United States
(12) Patent Application Publication
(10) Pub. No.: US 2009/0016191 A1
(43) Pub. Date: Jan. 15, 2009

(54) OPTICAL HEAD DEVICE

(75) Inventors: Koichi MURATA, Tokyo (JP); Yoshiharu OOI, Tokyo (JP); Yukihiro TAO, Fukushima (JP); Koji MIYASAKA, Fukushima (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Asahi Glass Company, Limited, Chiyoda-ku (JP)

(21) Appl. No.: 12/211,461

(22) Filed: Sep. 16, 2008

Related U.S. Application Data
(63) Continuation of application No. PCT/JP07/55123, filed on Mar. 14, 2007.

(30) Foreign Application Priority Data
Mar. 16, 2006 (JP) 2006-072671

(51) Int. Cl. G11B 7/00

(52) U.S. Cl. 369/110.01

(57) ABSTRACT

It is provided an optical head device which includes: a light source; an objective lens, configured to converge light emitted from the light source to an information recording surface of an optical disk; a beam splitter, configured to deflect returned light reflected by the optical disk into an optical path which is different from an optical path of the light emitted from the light source; a photo detector, configured to detect the returned light deflected by the beam splitter; and a depolarizing element, disposed on an optical path between the beam splitter and the photo detector, and configured to cause the returned light to transmit through while reducing a degree of polarization of the returned light.

### TECHNICAL FIELD

The present invention relates to an optical head device that needs to perform reading and writing with respect to an optical recording medium (hereinafter referred to as “optical disk”) such as a CD and a DVD, and more particularly, with respect to a multi-layer optical disk having a plurality of information recording layers.

### BACKGROUND ART

Optical disks include a single-layer optical disk having a single information recording layer and a multi-layer optical disk having a plurality of information recording layers. When information reading or writing is performed with respect to, for instance, a two-layer disk having two recording layers, return light that returns to a photo detector is influenced by light reflected from an adjacent information recording layer as well as by light reflected from an information recording layer on which light emitted from the light source has been converged. An optical head device that performs reading and writing with respect to a multi-layer optical disk must be configured in such a way that such interlayer crosstalk does not affect a servo signal. The word “reading and writing” employed herein is a generic designation of a reading operation, a writing operation, or a reading/writing operation with respect to an optical disk.

FIG. 17 shows a schematic diagram of optical paths achieved, during reading of information from a two-layer optical disk, in a conventional optical head device that performs reading and writing with respect to a multi-layer optical disk. Provided that a layer of the two-layer optical disk close to a light incidence plane is an L1 layer and that a layer of the two-layer optical disk far from the light incidence plane is an L2 layer, a focal point of light L12 reflected from the layer L2 is situated forward of a focal point of light L11 received by a photo detector during reading of information from the L1 layer. In the meantime, a focal point of light L21 reflected from the layer L1 is situated rearward of a focal point of light L22 received by the photo detector during reading of information from the layer L2.

Of the light returned from the L1 layer during reading of information from the L1 layer, the zeroth order diffracted light and the positive and negative first order diffracted light, which have been diffracted by a diffracting element, are converged on detection faces of respective photo detectors. Although the return light reflected from an L2 layer has a large beam size and low light density, the return light irradiates the detection face of the photo detector as stray light, thereby causing interference with the light returned from the L1 layer in the photo detector. When a change occurs in conditions for light interference for reasons of variations in an interval between information recording layers or in the wavelength of the light source, signal intensity changes, thereby raising a problem of a deterioration in reading performance. An optical head device, such as that described in; for instance, Patent Document 1, has hitherto been proposed as measures against the change. Namely, a hologram element, such as that shown in FIG. 18, is disposed in a light flux to diffract a portion of light returned from an optical disk, thereby eliminating stray light irradiating a photo detector for a sub-beam.

Patent Document 1: Japanese Patent Publication No. 2005-203090A

### DISCLOSURE OF THE INVENTION

### Problem to be Solved by the Invention

However, in the configuration described in Patent Document 1, light originating from the L1 layer from which information is originally desired to be read as well as stray light from the L2 layer are diffracted by the hologram element, which raises a problem of the light intensity of a signal entering the photo detector being also decreased.

The present invention has been conceived to solve the problem of the conventional art and aims at providing an optical head device capable of reading and writing information with respect to a multi-layer optical disk without involvement of a decrease in the intensity of a signal to the photo detector.

### How to Solve the Problem

(1) An optical head device according to the invention comprises:

a light source;

an objective lens, configured to converge light emitted from the light source to an information recording surface of an optical disk;

a beam splitter, configured to deflect returned light reflected by the optical disk into an optical path which is different from an optical path of the light emitted from the light source;

a photo detector, configured to detect the returned light deflected by the beam splitter; and

a depolarizing element, disposed on an optical path between the beam splitter and the photo detector, and configured to cause the returned light to transmit through while reducing a degree of polarization of the returned light.

With the above configuration, the degree of polarization of light emitted from the light source to the optical disk is decreased, to thus enable a decrease in the degree of polarization achieved when return light from the optical disk is incident on the photo detector and detected without involvement of a decrease in a characteristic for converging light on the optical disk. Consequently, when the multi-layer optical disk is subjected to reading or writing, the degrees of polarization of return light beams from respective layers of the multi-layer disk are reduced, thereby diminishing interference of the light beams at the photo detector. Thereby, even when a change occurs in conditions for interference of light from a one layer to be subjected to reading or writing and light from another layer for reasons of a change in an interval between layers of the multi-layer disk or a change in the wavelength of light from the light source, a decrease in reading performance, which would otherwise be caused as a result of a change in the intensity of a signal, can be prevented, and the multi-layer disk can be subjected to reading and writing by superior characteristics.

(2) In the optical head of the aspect (1) of the invention, it is preferable that: the depolarizing element has a birefringent layer comprised of a birefringent material; and at least one of a phase difference and an optic axis is different in accordance with a position on a surface of the depolarizing element, so that a polarized state of the returned light transmitted through the depolarizing element is changed in accordance with a position on the surface of the depolarizing element on which the returned light is incident.

Return light beams from the respective layers of the optical disk incident on the same position on the photo detector differ from each other in terms of a focusing state and therefore transmit through different positions on the depolarizing element. With the above configuration, the optical head device of the present invention causes the return light beams to transmit in mutually-different polarized states according to a location where the return light transmits through the surface of the depolarizing element, so that interference among the return light beams from the respective layers developing on the photo detector can be diminished.

(3) In the optical head of the aspect (1) or (2) of the invention, it is preferable that the depolarizing element is configured to change the polarized state such that the degree of polarization of the returned light is made to be 0.5 or less.

With the above configuration, interference among the return light beams from respective layers of the multi-layer disk can be further reduced. Moreover, the degree of polarization is reduced to be 0.25 or less or substantially zero; namely, a state where polarization does not arise, whereby interference can be further reduced. When interference is diminished, a change in the intensity of a signal attributable to a change in the interval of layers in the multi-layer disk or a change in the wavelength of light from the light source is reduced, so that a drop in reading performance can be preferably reduced.

(4) In the optical head of the aspect (2) or (3) of the invention, it is preferable that a region of the birefringent layer to be situated within a light flux of the light incident on the depolarizing element is divided into a plurality of areas such that polarized states of light transmitting through adjacent ones of the areas are made different from each other.

With the above configuration, the polarized state of transmitting light can be changed at respective positions where return light beams from the respective layers of the optical disk is incident on the depolarizing element. Hence, interference of the return light beams from the respective layers arising on the photo detector can be effectively reduced.

(5) In the optical head of the aspect (4) of the invention, it is preferable that the region of the birefringent layer to be situated within the light flux of the light incident on the depolarizing element is radially divided so that the areas are arranged around an optical axis of the optical path as a center, such that the polarized states of light transmitting through the areas become identical at a cycle of 360/j degrees in a circumferential direction as to the optical axis a is an integer of 2 or more).

With the above configuration, the degree of polarization V for a light flux, which is only a portion of light falling within an incident light flux, is reduced, whereby interference is preferably reduced. Moreover, when a photo detector having divided 2 or 4 light receiving areas is used, a plurality of return light beams converted into different polarized states are incident on the respective light receiving areas, whereupon a reading characteristic is enhanced.

(6) In the optical head of the aspect (4) of the invention, it is preferable that the region is divided so that the areas are arranged concentrically with an optical axis of the optical path as a center.

With the above configuration, fluctuations in the degree of polarization V are kept to a small level even when incident light is decentered, whereby a superior reading characteristic is maintained.

(7) In the optical head of the aspect (4), (5) or (6) of the invention, it is preferable that: the region of the birefringent layer to be situated within the light flux of the light incident on the depolarizing element is divided into a plurality of areas such that polarized states of light transmitting through the respective areas are made different from each other; and a relationship (1) is satisfied when the polarized states of the light transmitting through the adjacent ones of the areas are respectively represented as (1, S₁₀, S₂₀, S₃₀) and (1, S₁₁, S₂₁, S₃₁) by using a normalized Stokes parameter (S₀ₖ=1, S₁ₖ, S₂ₖ, S₃ₖ).

0<(S₁₀−S₁₁)²+(S₂₀−S₂₁)²+(S₃₀−S₃₁)²≦3 (1)

When a difference γ between polarized states of adjacent areas is great, the light transmitted through the depolarizing element divided into a plurality of areas undergoes diffraction at a boundary between the areas, thereby deteriorating the utilization efficiency of light. Provided that the difference between polarized states of adjacent areas is γ=(S₁₀−S₁₁)²+(S₂₀−S₂₁)²+(S₃₀−S₃₁)², occurrence of diffraction between adjacent areas can be preferably prevented by setting the difference so as to fall within a range of 0<γ≦3.

For instance, when the value of γ is very large, as in the case of γ=4, diffraction efficiency reaches 40% (the sum of positive and negative first-order light beams), and the efficiency of transmitted light that has not undergone diffraction is reduced to about 50%, and a large drop occurs in transmittance. In contrast, it is preferable to increase the number of areas into which the element is to be split, to thereby decreasing a phase difference between adjacent areas or changes in optic axes, and to reduce the difference γ between polarized states of adjacent areas. At γ=3, the efficiency of transmitted light having not undergone diffraction comes to 75% or more, and a decrease in transmittance preferably comes to a level at which no practical problem occurs. Moreover, at γ=2, the efficiency of transmitted light not having undergone diffraction comes to 85% or more, and a decrease in transmittance more preferably comes to a level at which no practical problem occurs. Further preferably, γ=1.5 and, moreover, γ≦1, are achieved, a diffraction loss can be preferably reduced further.

(8) In the optical head of the aspect (4), (5) or (6) of the invention, it is preferable that: the birefringent layer is divided into four areas or more; and a relationship (2) is satisfied when the polarized states of the light transmitting through ones of the areas which are shifted from each other by approximately 90 degrees in a circumferential direction as to the optical axis are respectively represented as (1, S₁₃, S₂₃, S₃₃) and (1, S₁₄, S₂₄, S₃₄) by using a normalized Stokes parameter (S₀ₖ=1, S₁ₖ, S₂ₖ, S₃ₖ).

2≦(S₁₃−S₁₄)²+(S₂₃−S₂₄)²+(S₃₃−S₃₄)²<4 (2)

On condition that the difference γ[=(S₁₃−S₁₄)²+(S₂₃−S₂₄)²+(S₃₃−S₃₃)²] between polarized states of light transmitting through two areas separated from each other through substantially 90 degrees is arranged so as to satisfy the relationship (2), when the optical head device using an astigmatic method as a focusing servo technique subjects a multi-layer optical disk to reading or writing, light from a one layer to be subjected to reading or writing and stray light from another layer except the one layer are converted on a detection surface of the photo detector while being rotated through 90 degrees around the optical axis of the beams. Further, the light beams can be converged in greatly-different polarized states, whereby interference can be diminished. The term “approximately 90 degrees” in the present specification signifies 67.5 degrees to 112.5 degrees.

Moreover, it is more preferable that the birefringent layer is divided into eight areas or more; that polarized states of light beams transmitting through two areas separated from each other through about 90 degrees satisfy the relationship (2); and that the difference γ between the polarized states of light beams transmitting through adjacent areas satisfies the Equation (1).

(9) In the optical head of the aspect (2), (3) or (4) of the invention, it is preferable that: a region of the birefringent layer to be situated within the light flux of the light incident on the depolarizing element is divided into a plurality of areas; and an interval between centers of the areas falls within a range from 30 μm to 3 mm; and optic axes in each of the areas are directed radially or concentrically.

With the above configuration, even when incident light is incident, in a decentered state, on the center of the depolarizing element, light exhibiting a very small degree of polarization transmits through the element, and hence assembly and adjustment of the optical head device are facilitated, and a shift characteristic of the objective lens can be enhanced.

(10) In the optical head of the aspect (2), (3) or (4) of the invention, it is preferable that: the phase difference of the birefringent layer is constant; and the optic axis of the birefringent layer is directed radially or concentrically with respect to an optical axis of the optical path as a center.

With the above configuration, return light from an information recording layer of the multi-layer optical disk is incident on the photo detector while being polarized so as to exhibit a 90-degree rotational symmetry around the centers of respective light receiving areas, and the degrees V of polarization achieved in the respective light receiving areas approximate zero. Hence, interference is diminished, and a superior reading characteristic is realized.

In this case, polarized states of light beams transmitting through two areas separated from each other through about 90 degrees with reference to the optical axis of the depolarizing element are expressed as (1, S₁₃, S₂₃, S₃₃) and (1, S₁₄, S₂₄, S₃₄) by use of normalized Stokes parameters, the relationship (2) preferably stands for the same reason as the eighth aspect.

(11) In the optical head of any one of the aspects (4) to (10) of the invention, it is preferable that a phase difference of the birefringent layer is an odd multiple of one-half of a wavelength of the returned light incident on the depolarizing element.

With the above configuration, the degree of polarization of transmitted light can be effectively reduced. The phase difference is preferably set to one-half of the wavelength λ of incident light.

(12) In the optical head of the aspect (5) of the invention, it is preferable that: the birefringent layer is divided into 4 areas each of which has an area corresponding to 90 degrees in the circumferential direction of the birefringent layer; and optic axes of adjacent ones of the areas are angled by 90 degrees from each other, and angled by 45 degrees from a polarized direction of the returned light incident on the depolarizing element.

With the above configuration, optical interference arising between layers as a result of return light from a one layer interfering with return light from another layer is reduced, and crosstalk is reduced.

(13) In the optical head of the aspect (4) of the invention, it is preferable that the region of the birefringent layer to be situated within the light flux of the light incident on the depolarizing element is divided into a first area arranged concentrically with an optical axis of the optical path, and a second area which is an area other than the first area.

With the above configuration, the degree of polarization V of light transmitting through the depolarizing element is reduced by a depolarizing element that is easy to fabricate and has a simple configuration, so that interference between the main beam and stray light can be decreased.

(14) In the optical head of the aspect (4) of the invention, it is preferable that the region of the birefringent layer to be situated within the light flux of the light incident on the depolarizing element is divided into a first area and a second area which are arranged symmetrically with an optical axis of the optical path, and a third area which is an area other than the first area and the second area.

With the above configuration, the polarized state of return light of a sub-beam from the one layer and the polarized state of stray light from another layer can be made considerably different from each other, so that interference and crosstalk are diminished.

### ADVANTAGE OF THE INVENTION

The present invention can provide an optical head device exhibiting an effect of the ability to perform reading and writing information with respect to a multi-layer disk without involvement of a decrease in the intensity of a signal to a photo detector.

### BRIEF DESCRIPTION OF THE DRAWINGS

FIG. 1 is a view showing a schematic configuration of an optical head device according to one embodiment of the present invention.

FIG. 2 is a schematic view showing converged light spots received by a photo detector of the optical head device according to one embodiment of the present invention.

FIG. 3(a) is a plan view schematically showing a depolarizing element according to a first embodiment of the invention.

FIG. 3(b) is a plan view schematically showing polarized states of light transmitted through the depolarizing element of the first embodiment.

FIG. 4(a) is a plan view schematically showing a depolarizing element according to a second embodiment of the invention.

FIG. 4(b) is a plan view schematically showing polarized states of light transmitted through the depolarizing element of the second embodiment.

FIG. 5(a) is a plan view schematically showing a depolarizing element according to a third embodiment of the invention.

FIG. 5(b) is a plan view schematically showing polarized states of light transmitted through the depolarizing element of the third embodiment.

FIG. 6 is a plan view schematically showing an example in which the depolarizing element of the third embodiment is divided into 24 areas.

FIG. 7(a) is a plan view schematically showing an example in which the depolarizing element of the third embodiment is divided into 4 areas.

FIG. 7(b) is a plan view schematically showing polarized states of light transmitted through the depolarizing element of FIG. 7(a).

FIG. 8 is a plan view schematically showing a configuration of a polarization selecting element which is preferably used with the depolarizing element of FIGS. 7(a) and 7(b).

FIG. 9(a) is a plan view schematically showing a depolarizing element according to a fourth embodiment of the invention.

FIG. 9(b) is a plan view schematically showing polarized states of light transmitted through the depolarizing element of the third embodiment.

FIG. 10(a) is a plan view schematically showing a depolarizing element according to a fifth embodiment of the invention.

FIG. 10(b) is an enlarged plan view schematically showing adjacent regular hexagonal areas in the depolarizing element of the fifth embodiment.

FIG. 11 is a plan view schematically showing a depolarizing element according to a sixth embodiment of the invention.

FIG. 12 is a plan view schematically showing a depolarizing element according to a seventh embodiment of the invention.

FIG. 13 is a plan view schematically showing an another example of a depolarizing element of the seventh embodiment.

FIG. 14 is a plan view schematically showing a depolarizing element according to an eighth embodiment of the invention.

FIG. 15 is a plan view schematically showing a depolarizing element according to a ninth embodiment of the invention.

FIG. 16 is a section view schematically showing a depolarizing element according to the invention, wherein polymer liquid crystal is used as a birefringent medium layer to form a concentric distribution of a phase difference magnitude.

FIG. 17 is a schematic view showing optical paths of when a two-layer optical disk is subjected to reading operation.

FIG. 18 is a schematic view of a conventional hologram element which diffracts a portion of light returned from an optical disk.

Description of Reference Numerals

| | |
|---|---|
| 1 | light source |
| 2 | diffracting element |
| 3 | collimator lens |
| 4 | beam splitter |
| 5 | objective lens |
| 6 | optical disk |
| 6a | information recording surface |
| 7 | collimator lens |
| 8 | depolarizing element |
| 9 | photo detector |
| 11, 12, 13 | light receiving areas |
| 15, 17 | converged light spot of sub-beams |
| 16 | converged light spot of main beam |
| 18 | converged light spot of returned light to be stray light |
| 20 | arrows representing polarized direction |
| 21-28, 131-138, | divided areas |
| 171-174, 181-184 | |
| 31, 32, 121-123, | divided areas |
| 151-153, 161-163 | |
| 34, 35 | arrows representing polarized direction |
| | of light transmitted through respective |
| | divided areas |
| 41-45 | divided areas |
| 51, 53 | substrate |
| 52 | polymer liquid crystal layer |
| 54 | transparent medium layer |
| 60 | incident light flux |
| 100 | optical head device |

### BEST MODE FOR IMPLEMENTING THE INVENTION

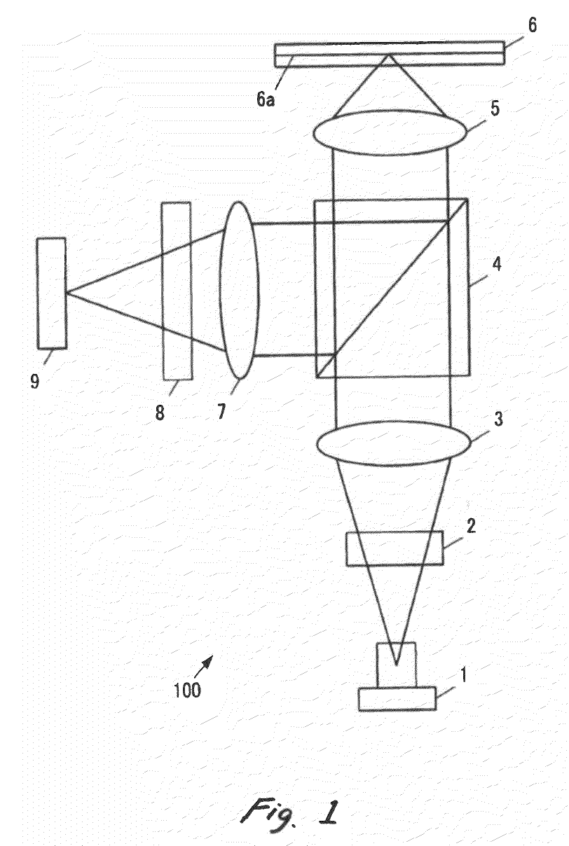

FIG. 1 is a view showing a conceptual configuration of an optical head device 100 of the present embodiment. In FIG. 1, the optical head device 100 comprises a light source 1 that emits a light flux having a predetermined wavelength; a diffracting element 2 that generates three beams, i.e., a main beam and two sub-beams, by diffracting a portion of the light flux emitted from the light source 1; a collimator lens 3 that converts an incident light flux into substantially-collimated light; a beam splitter 4 that causes the three beams emitted from the collimator lens 3 to transmit and that subject return light of the three beams reflected from an information recording surface 6a of an optical disk 6 to deflecting separation, thereby guiding the thus-separated light to a photo detector 9; an objective lens 5 that converges the three beams on the information recording surface 6a of the optical disk 6; a collimator lens 7 that converges the return light of the three beams at the photo detector 9; an depolarizing element 8 that changes a polarized state of light to be passed, thereby decreasing the degree of polarization V; and the photo detector 9 that detects return light of the three beams.

A portion of the light flux emitted from the light source 1 is diffracted by the diffracting element 2, to thus be converted into three beams; namely, the main beam and the two sub-beams. The three beams transmit through the collimator lens 3 and the beam splitter 4 in this sequence and converged on the desired information recording surface 6a of the optical disk 6 by the objective lens 5. The three beams converged on the information recording surface 6a of the optical disk 6 undergo reflection on the information recording surface 6a, respectively; transmit through the objective lens 5; undergo reflection on the beam splitter 4; and are incident on the photo detector 9 by way of the collimator lens 7 and the depolarizing element 8.

The photo detector 9 reads a read signal pertaining to information recorded on the desired information recording surface 6a of the optical disk 6, a focus error signal, and a tracking error signal, thereby generating an output signal. The optical head device 100 has a mechanism (a focus servo) that controls the lens in the direction of an optical axis in accordance with the focus error signal and a mechanism (a tracking servo) that controls the lens in a direction substantially perpendicular to the optical axis in accordance with the tracking error signal, but these mechanisms are omitted from the schematic diagram shown in FIG. 1.

The light source 1 is made up of a semiconductor laser that emits a linearly-polarized divergent light flux having a wavelength of 650 nm or thereabouts. The wavelength of the light source 1 used in the present invention is not always limited to a value of 650 nm or thereabouts and may also assume a value of; for instance 400 nm or 780 nm or thereabouts. Wavelengths of 400 nm, 650 nm, 780 nm or thereabouts mean wavelengths falling within ranges from 385 nm to 430 nm, 630 nm to 690 nm, and 760 nm to 800 nm, respectively.

The light source 1 may also be configured so as to emit light fluxes having two or three wavelengths. A so-called hybrid two-wavelength laser light source or three-wavelength laser light source including two or three semiconductor laser chips mounted on a single substrate or a monolithic two-wavelength laser light source or three-wavelength laser light source having two or three light-emitting points can be mentioned as the light source of such a configuration.

The depolarizing element 8 has a birefringent layer made from a birefringent material exhibiting a birefringent characteristic. For instance, a single crystal exhibiting a birefringent characteristic, such as a crystal or LiNbO₃ (lithium niobate), a resin film exhibiting a birefringent characteristic, an injection-molded article, or the like, can be used as the birefringent material. Alternatively, there can also be employed a structural birefringent material obtained by processing a layer laid on a substrate or the surface of the substrate, to thus create a minute periodic structure having periodicity which is approximately equal to or shorter than the wavelength of light for which the element of the present invention is used. Use of the structural birefringent material is preferable, because it enables free designing of the direction of the optic axis and the magnitude of a phase difference. Further, use of polymer liquid crystal produced by polymerization of liquid crystal serving as a birefringent material is preferable, because it enables facilitation or free setting of the direction of a slow axis by controlling the orientation of a liquid crystal. FIG. 1 illustrates an embodiment in which the depolarizing element 8 is interposed between the collimator lens 7 and the photo detector 9. However, the present invention is not limited to the embodiment, and the depolarizing element 8 may also be interposed between the beam splitter 4 and the collimator lens 7.

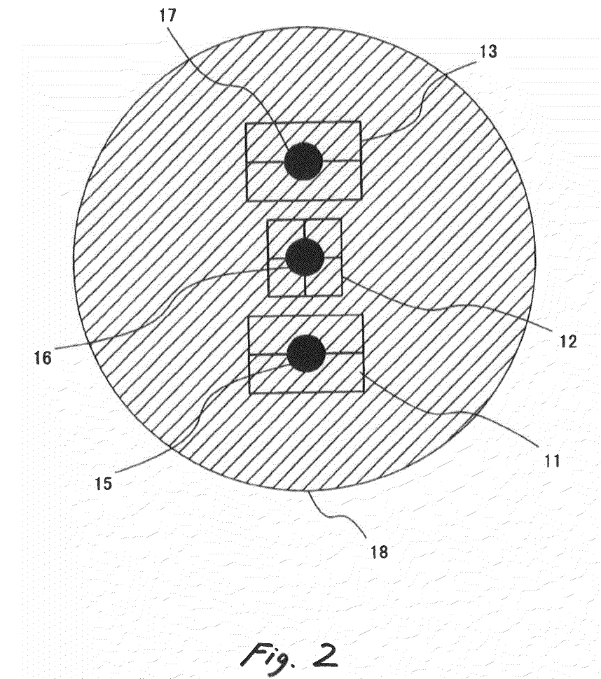

The state of return converged light on a light receiving surface of the photo detector 9 achieved when information recorded in the information recording layer of the multilayer optical disk is read will be described by reference to the drawings. FIG. 2 schematically illustrates an example state of return converged light on the light receiving surface of the photo detector 9. The light receiving surface of the photo detector 9 has a plurality of light receiving areas 11, 12, and 13. Return light reflected from a desired information recording layer of the optical disk is converged within the light receiving area, thereby creating converged light spots 15, 16, and 17. The converged light spot 16 is one formed from the zeroth order diffracted light emitted from the diffracting element 2; namely, a main beam. The converged light spots 15 and 17 are those formed from the positive and negative first order diffracted light; namely, the sub-beams. The converged light spot 18 designates one formed from stray light caused by reflection on information recording layers other than the desired information recording layer; remains in a defocused state on the light receiving surface of the photo detector 9; and has a large spot size, such as that shown in FIG. 2.

The converged light spot 18 of stray light overlaps the light receiving areas 11, 12, and 13. Hence, the conventional optical head device has a problem of interfering with the converged light spots 15, 16, and 17, thereby generating noise. In particular, the sub-beam is smaller in light quantity than the main beam; namely, one-tenth of the light quantity of the main beam or less, and hence is especially vulnerable to influence of noise, to thus result in a deterioration in tracking performance. When variations arise in an interval between information recording layers of the multilayer optical disk or an emission wavelength of the light source, conditions for interference are further changed, to thus increase noise further, which particularly presents a problem.

In contrast, in the optical head device 100 of the present invention, the degree of polarization of return light of the main beam or the sub-beam converged on the photo detector 9 and the degree of polarization of stray light that is to become the converged light spot 18 are reduced, as will be described later, as a result of use of the depolarizing element 8, whereby interference is prevented. As a result, in the optical head device 100 of the present invention, variations in light quantity of a signal induced by changes in an interval between recording layers of an optical disk and the wavelength of the light source are reduced to a small level, so that a reading and writing characteristic can be enhanced. Seven embodiments of the depolarizing element 8 used in the optical head device 100 of the present invention are mentioned hereunder and will be specifically explained by reference to the drawings.

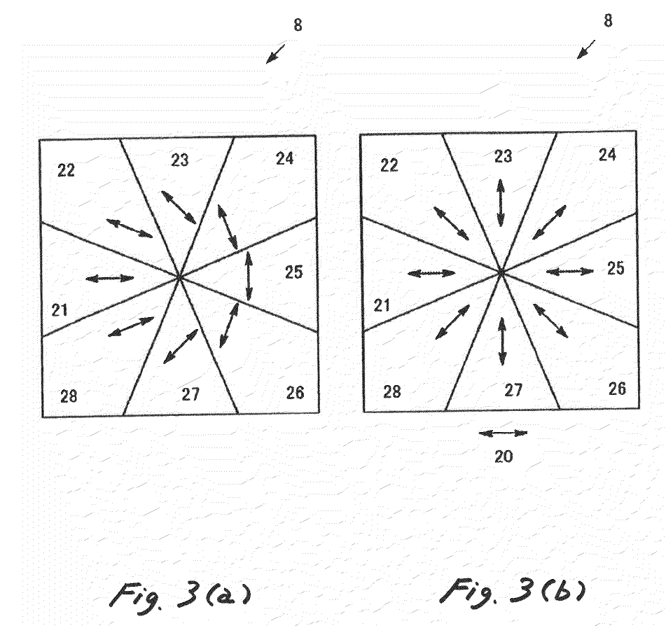

As shown in FIG. 3(a), in a first embodiment of the depolarizing element 8, the birefringent layer including a birefringent medium exhibiting a birefringent characteristic has areas 21 to 28 radially divided into eight segments while centering around the optical axis. The respective areas 21 to 28 have different optic axes from one another as shown in arrows in FIG. 3(a). A phase difference of the birefringent medium is set to one-half of the wavelength of the semiconductor laser.

FIG. 3(b) shows the direction of polarization of transmitted light achieved when light linearly polarized in a direction 20 shown in FIG. 3(b) is incident on the depolarizing element 8 having the configuration shown in FIG. 3(a). Beams transmitted through the respective areas 21 to 28 of the depolarizing element 8 are linearly-polarized beams whose directions of polarization are different in the radially-divided eight areas around the optical axis; namely, light having a plurality of directions of polarization. Hence, a degree of polarization V achieved over the entire light flux transmitted through the depolarizing element 8 decreases. Consequently, in the first embodiment of the depolarizing element 8, the degree of polarization V comes to zero when the light beams transmitted through the areas 21 to 28 have the same light quantity.

In order to represent a polarized state of light, descriptions are provided by use of a stokes parameter. A brief explanation is provided hereunder to the stokes parameter. Detailed explanations of the stokes parameter are provided in; for instance, Chapter 5-3 “Notation of polarization,” “Applied Optics 2,” Baifukan Co., Ltd.

When consideration is given to light that propagates in direction “z” in a coordinate system (x, y, z), Ex and Ey, which are “x” and “y” components of light, are expressed by the following expressions.

Eₓ=Aₓ·exp[j(ωt−k_{z}+δₓx)] (3)

E_{y}=A_{y}·exp[j(ωt−k_{z}+δ_{y})] (4)

where ω denotes an angular frequency; “k” denotes a wavenumber vector; δₓ and δ_{y} denote the phase of light in the direction “x” and the phase of light in the direction “y”; and Aₓ and A_{y} denote amplitudes of electric fields achieved in “x” and “y” directions.

A polarization state can be expressed by a stokes parameter (S₀, S₁, S₂, S₃) consisting of four parameters.

S₀=<Aₓ²>+<A_{y}²> (5)

S₁=<Aₓ²>−<A_{y}²> (6)

S₂=2<AₓA_{y} cos δ> (7)

S₃=2<AₓA_{y} sin δ> (8)

where δ=δ_{y}−δₓ, and a symbol < > denotes a mean value of a sufficiently-long time.

Symbol S₀ denotes a parameter expressing light intensity, and therefore a polarized state of light can be expressed by a normalized stokes parameter standardized by S₀=1. Specifically, the normalized stokes parameter is represented as follows:

S₀=1 (9)

S₁=[<Aₓ²>−<A_{y}²>]/[<Aₓ²>+<A_{y}²>] (10)

S₂=2<AₓA_{y} cos δ>/[<Aₓ²>+<A_{y}²>] (11)

S₃=2<AₓA_{y} sin δ>/[<Aₓ²>+<A_{y}²>] (12)

The degree of polarization V can also be expressed by the following equation.

V=(S₁²+S₂²+S₃²)^{1/2}/S₀ (13)

When polarized states of the light beams transmitted through the areas 21 to 28 shown in FIG. 3(b) are denoted by the normalized Stokes parameter, the light beam transmitted through the areas 21 and 25 can be expressed as (S₀, S₁, S₂, S₃)=(1, 1, 0, 0); the light beam transmitted through the areas 22 and 26 can be expressed as (S₀, S₁, S₂, S₃)=(1, 0, 1, 0); the light beam transmitted through the areas 23 and 27 can be expressed as (S₀, S₁, S₂, S₃)=(1, −1, 0, 0); and the light beam transmitted through the areas 24 and 28 can be expressed as (S₀, S₁, S₂, S₃)=(1, 0, −1, 0). A normalized Stokes parameter for a light flux formed by combination of these light beams comes to (S₀, S₁, S₂, S₃)=(1, 0, 0, 0), and the degree of polarization V comes to zero.

Provided that polarized states of adjacent areas; for instance, 21 and 22, are expressed as (S₀₀, S₁₀, S₂₀, S₃₀) and (S₀₁, S₁₁, S₂₁, S₃₁), the parameters are defined as (1, 1, 0, 0) and (1, 0, 1, 0). A difference between the polarized states of these areas is evaluated by γ which is represented as (S₁₀−S₁₁)²+(S₂₀−S₂₁)²+(S₃₀−S₃₁)², the following equation is obtained.

$$\begin{matrix}γ = {( {S}_{10} - {S}_{11} )}^{2} + {( {S}_{20} - {S}_{21} )}^{2} + {( {S}_{30} - {S}_{31} )}^{2} \\ = {( 1 - 0 )}^{2} + {( 0 - 1 )}^{2} + {( 0 - 0 )}^{2} \\ = 2\end{matrix} \qquad ( 14 )$$

Consequently, according to the first embodiment of the depolarizing element 8, causing γ to be 2, diffraction induced by the difference between the polarized states of the areas can be preferably reduced to a small level. The essential requirement for the depolarizing element 8 having the present embodiment is that transmitted light be emerged in a polarized state shown in FIG. 3(b) from each of the areas. Phase differences among the areas of the depolarizing element 8 and the configuration of the depolarizing element viewed in the direction of the optic axis are not limited to those shown in FIG. 3(a).

Transmitted light emerged from the depolarizing element 8 of the present embodiment is in a polarized state exhibiting 180-degree (j=2) rotational symmetry about the optical axis.

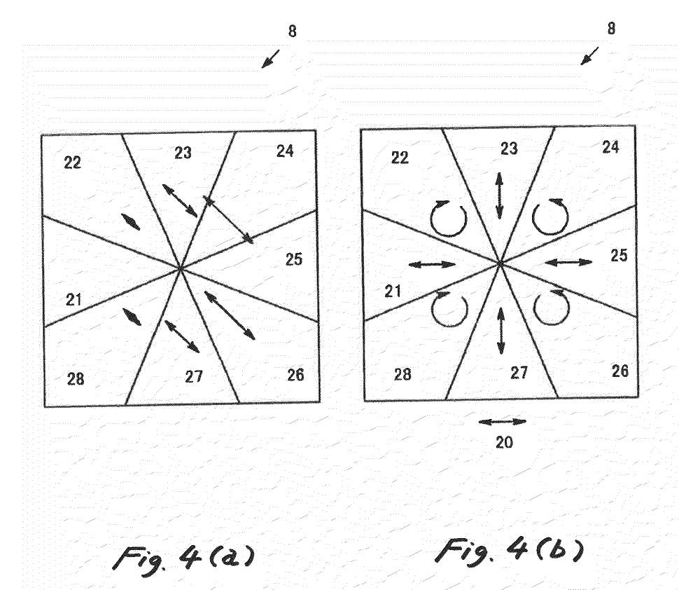

Another embodiment of the depolarizing element 8 of the first embodiment is schematically shown in FIGS. 4(a) and 4(b). In the depolarizing element 8 of the present embodiment, birefringent layers in the areas 21 through 28 defined by radial division of the birefringent layer into eight sub-areas centered on the optical axis exhibit different phase differences from one area to another but have the same orientation of the optic axis. Specifically, the second embodiment of the depolarizing element 8 is based on the assumption that, for instance, a phase difference between the areas 21 and 25 is zero; a phase difference between the areas 22 and 28 is λ/4 (λ denotes a wavelength of light emitted from the light source 1); a phase difference between the areas 23 and 27 is λ/2; and a phase difference between the areas 24 and 26 is 3λ/4. When linearly-polarized light polarized in a direction designated by arrow 20 is caused to be incident on the depolarizing element 8, transmitted light turns into linearly-polarized light whose direction of polarization varies from one area to another and circularly-polarized light whose rotating direction changes from one area to another, whereupon the polarized state of the transmitted light turns into polarized states that change from one area to another in the eight areas radially divided with respect to the optical axis.

Provided that transmitted light is expressed by a normalized Stokes parameter in each area, light transmitted through the areas 21 and 25 can be expressed as (S₀, S₁, S₂, S₃)=(1, 1, 0, 0); the light beam transmitted through the areas 22 and 28 can be expressed as (S₀, S₁, S₂, S₃)=(1, 0, 0, 1); the light beam transmitted through the areas 23 and 27 can be expressed as (S₀, S₁, S₂, S₃)=(1, −1, 0, 0); and the light beam transmitted through the areas 24 and 26 can be expressed as (S₀, S₁, S₂, S₃)=(1, 0, 0, −1). A normalized Stokes parameter for a light flux formed by combination of these light beams comes to (S₀, S₁, S₂, S₃)=(1, 0, 0, 0), and the degree of polarization V comes to zero. The difference γ between polarized states of adjacent areas comes to 2. The difference γ between polarized states of areas separated 90 degrees from each other with reference to the optical axis; for instance, polarized states of the areas 21 and 25 and polarized states of the areas 23 and 27, comes to 2.

According to the second embodiment of the depolarizing element 8, an aligned orientation of the optic axis can be attained in the areas provided in the depolarizing element 8, and diffraction attributable to a difference between polarized states of areas can be preferably reduced to a small level. The depolarizing element 8 of the second embodiment is also preferable, because manufacture of the element is easy. The minimum requirement for the depolarizing element 8 of the present embodiment is that transmitted light be emerged in a polarized state shown in FIG. 4(b) from each of the areas. A phase difference among the areas and the directions of the optic axes of the depolarizing element 8 are not limited to those shown in FIG. 4(a).

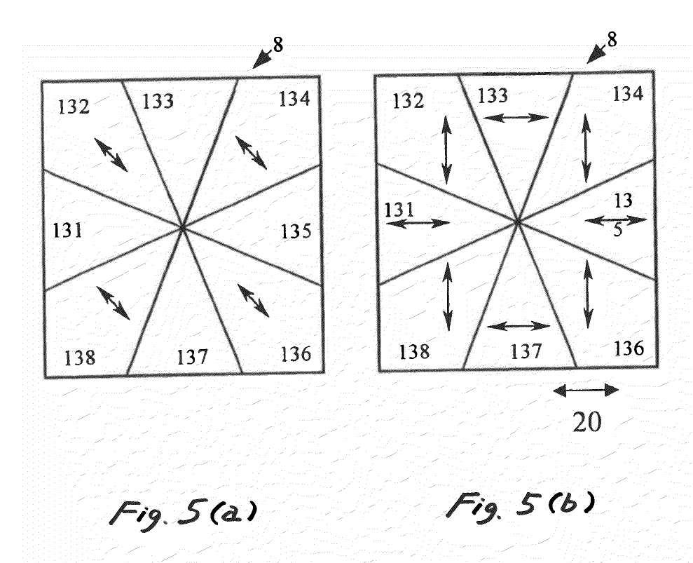

FIGS. 5(a) and 5(b) show a still another embodiment of the depolarizing element 8 of the first embodiment. As shown in FIG. 5(a), the depolarizing element 8 of the embodiment has eight areas 131 to 138 into which a birefringent layer is radially divided while the optical axis is taken as the center. A phase difference exists among four areas 131, 133, 135, and 137 that are alternate areas in the eight areas is zero. In the other four areas that are also alternate areas in the eight, an optic axis forms an angle of 45 degrees with respect to the direction of polarization designated by the arrow 20, and a phase difference among the areas is taken as λ/2. The previously-described linearly-polarized light incident on the depolarizing element 8 of the present embodiment is emerged while being brought into the same polarized state at the areas exhibiting a 90-degree (j=4) rotational cycle, as shown in FIG. 5(b).

So long as the number of areas into which the depolarizing element 8 is radially divided while the optical axis is taken as the center is increased, to thus reduce an angle (360 degrees/j) of the rotational cycle for areas where transmitted light is incident on the same polarized state, the degree of polarization V can also be reduced for a partial light flux in a transmitted light flux, and interference can further be reduced. When the depolarizing element 8 is used for an optical head device, light receiving areas 11, 12, and 13 of the photo detector are generally divided into 2 or 4 sub-areas as shown in FIG. 2. Accordingly, in order to diminish interference by decreasing the degree of polarization V achieved in these light receiving areas, “j” preferably assumes a value of 4 or more. In the meantime, when “j” exceeds 40, the polarized state of a transmitted light flux from the depolarizing element changes steeply, and a diffraction phenomenon of light is unfavorably likely to arise. For this reason, “j” preferably assumes a value from 4 to 40 and, more preferably, from 4 to 12.

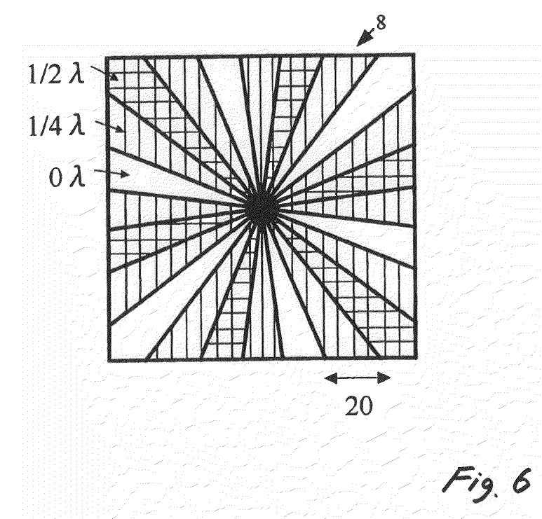

The depolarizing element shown in FIG. 6 has 24 areas radially divided with the optical axis being taken as the center. In the areas, the direction of the optic axis is assumed to form an angle of 45 degrees with the direction of polarization of incident light denoted by the arrow 20, and a difference between phases of adjacent areas is taken as λ/4. In the embodiment shown in FIG. 5, the polarized states of transmitted light exhibit 90-degree rotational symmetry (j=4), and a difference between phases of adjacent areas is λ/2. In contrast to the fact that the difference γ between polarized states of adjacent areas is 4, the polarized state of transmitted light achieved in an embodiment shown in FIG. 6 exhibits a 60-degree rotational symmetry (j=6); a difference between phases of adjacent areas is λ/4; and the difference γ between polarized states of adjacent areas is 2. Hence, a further decrease in diffraction arising between the areas is preferably attained. In order to further diminish diffraction arising between areas, it is preferable to reduce the difference between phases of adjacent areas.

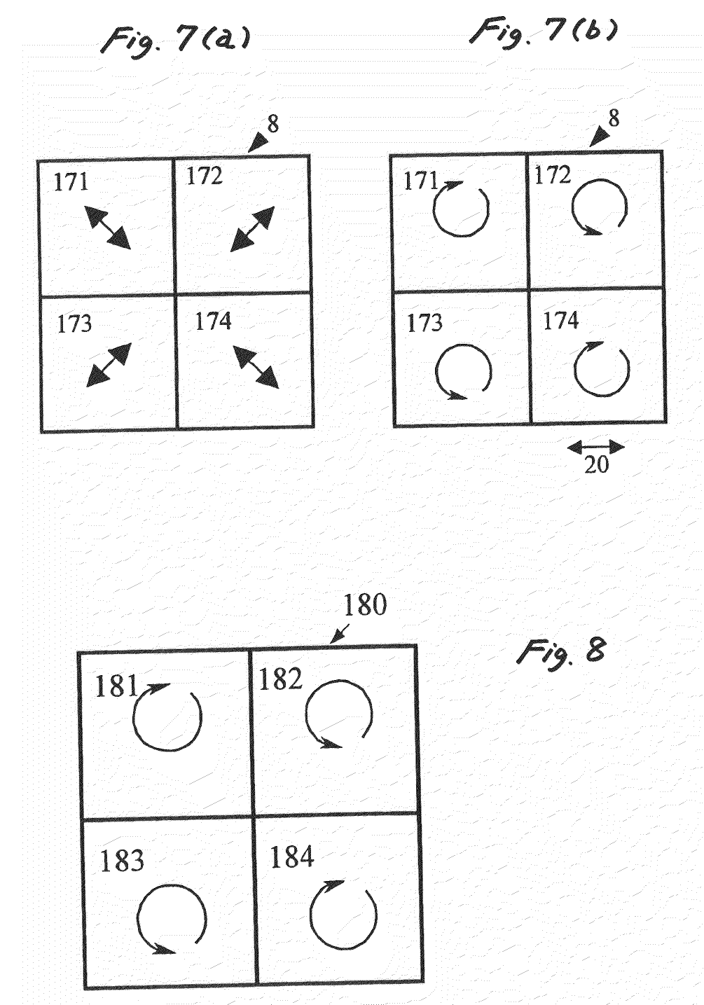

The depolarizing element 8 shown in FIGS. 7(a) and 7(b) is a still another embodiment of the depolarizing element 8 of the first embodiment. A birefringent layer formed from a birefringent material is radially divided into 4 areas 171 to 174 centered on the optical axis. The element is configured such that optic axes of adjacent areas form an angle of 90 degrees with each other and form an angle of 45 degrees with the direction of polarization of incident light denoted by the arrow 20. The magnitude of a phase difference among the areas is set to one-quarter of the wavelength of the incident light. In the embodiment whose plan view is shown in FIG. 7(a), the directions of respective optic axes are aligned in the same direction within the respective areas and assumed to be substantially radial with respect to the optical axis but can also be arranged in an substantially-concentric pattern; namely, in a direction orthogonal to the direction of the optic axis shown in FIG. 7(a).

Additional areas can also be provided between the four areas 171 to 174. As a result of provision of such additional areas, the difference y among the polarized states of the areas 171 to 174 is reduced, and diffraction of light arising in a boundary between the areas can be preferably suppressed.

As shown in FIG. 7(b), in relation to the polarized state of the light transmitted through the depolarizing element 8, transmitted light beams from adjacent areas become circularly-polarized light beams that are opposite in the direction of polarization and are brought into the same polarized state in areas exhibiting a 180-degree rotational cycle (j=2) and emerged from the areas. Further, the difference γ between polarized states of light transmitted through two areas spaced 90 degrees apart from each other comes to 4, and the degree of polarization V of a light flux formed by combination of the light beams transmitted through the depolarizing element 8 comes to zero. The difference γ between polarized states of adjacent areas comes to 4, whereby interference is sufficiently reduced. In particular, use of an optical head device that performs reading and writing with respect to a multi-layer optical disk enables a reduction in interlayer light interference resultant from return light from a one layer with return light from another layer.

When the depolarizing element 8 having the configuration shown in FIGS. 7(a) and 7(b) is used with the optical head device shown in FIG. 1 and when an astigmatic method is used as a focus servo technique, the direction of a focal line of astigmatism and the direction in which the depolarizing element is divided are selected to be parallel to each other, whereby return light from a desired information recording layer (a one layer) of the multi-layer optical disk transmitted through the respective areas of the depolarizing element 8 and light from another layer can be caused to be incident on the photo detector while positions of the light beams on the photo detector are rotated by 90 degrees. At this time, at respective positions on the photo detector, the difference γ between the polarized state of light from the one layer and the polarized state of light from another layer comes to 4, and crosstalk is diminished. This is greatly effective for reducing crosstalk of the main beam acquired when a three beam technique, such as a DPP technique, is used as the tracking technique or crosstalk of the main beam acquired when a one beam technique, such as a Push-Pull technique, is used.

When the depolarizing element 8 having the configuration shown in FIGS. 7(a) and 7(b) is used with the optical head device shown in FIG. 1, it is further preferable to place an unillustrated polarization selecting element 180 in an optical path between the depolarizing element 8 and the photo detector 9. As shown in a plan view of FIG. 8, the polarization selecting element 180 has four areas 181 to 184 radially divided with respect to the optical axis. Each of the thus-divided areas exhibits a polarization selecting characteristic. The polarization selecting element is configured so as to cause light incident on the polarization selecting element 180 to transmit at different transmittance or emerge in a different optical path in accordance with the polarized state of the incident light.

A cholesteric liquid crystal mirror formed from a cholesteric liquid crystal that differs from one area to another of the divided areas in terms of the direction of twist of liquid-crystal molecules is illustrated as such a polarization selecting element 180. The respective areas 181 to 184 shown in FIG. 8 reflect circularly-polarized light that rotates in a direction opposite to the illustrated direction of rotation, thereby causing circularly-polarized light in the same direction of rotation to pass. Further, a polarization diffraction grating that exhibits the same polarization selecting characteristic in each area and that diffracts incident light at different diffraction efficiencies may also be used.

The depolarizing element 8 and the polarization selecting element 180 are preferably arranged in the optical path while positions of their respective four-divided areas are aligned to each other, and the polarization selecting element 180 is preferably arranged as closely to the photo detector 9 as possible. By such a configuration, the return light from the desired information recording layer (the one layer) of the multi-layer optical disk transmitted through the respective areas of the depolarizing element 8 can be caused to transmit through the area of the polarization selecting element 180 exhibiting a corresponding polarization selecting characteristic. Light from another layer falls on the polarization selecting element 180 at a position that rotates 90 degrees with respect to the light from the one layer because of astigmatism. Therefore, the light from another layer is reflected by the respective areas of the polarization selecting element 180, so that the quantity of the light arriving at the photo detector is significantly reduced and that crosstalk is further diminished.

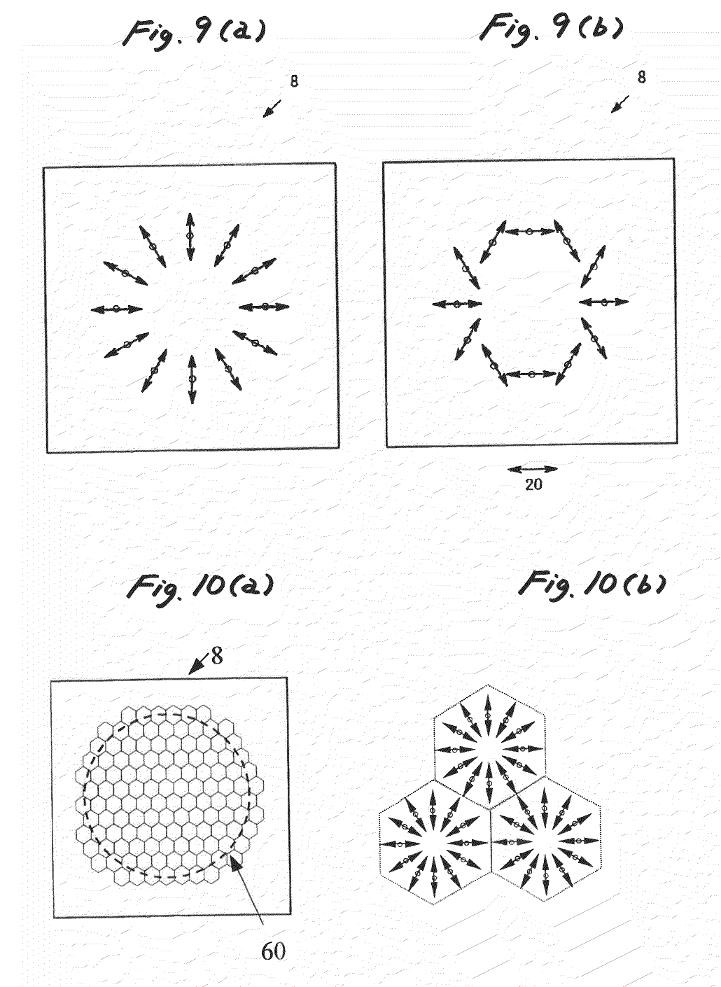

The second embodiment of the depolarizing element 8 has a structure in which the direction of the optic axis and the magnitude of a phase difference continually change depending on a position within the element surface instead of the structure in which the birefringent layer is divided into a plurality of areas as described in connection with the foregoing embodiments. The present embodiment shown in FIG. 9(a) has a structure in which the direction of the optic axis of the birefringent layer located within an incident light flux where light from the light source falls is made radial from the optical axis as a center, and in which a phase difference is set to one-half the wavelength λ of incident light.

When the direction of polarization of the light incident on the depolarizing element 8 corresponds to the direction of polarization designated by the arrow 20 shown in FIG. 9(b), the polarized state of transmitting light is as shown in FIG. 9(b). Specifically, the light beams transmitted through the depolarizing element 8 are individually polarized. However, when the entire transmitted light flux is observed, the flux becomes light having a plurality of directions of polarization, and the degree of polarization V is reduced to substantially zero. In the present embodiment, since transmitted light undergoes continual changes in a polarized state attributable to positions within the element surface, diffraction due to a difference in polarized states achieved in areas does not substantially arise, and hence the example is preferable. In FIGS. 9(a) and 9(b), polarized states designated by respective arrows represent polarized states achieved at positions designated by circles attached to the respective arrows. A phase difference among birefringent mediums may also be set to an odd multiple of λ/2 and preferably to λ/2. Even when the direction of the optic axis of the depolarizing element of the present embodiment is arranged to be a concentric pattern instead of the radial pattern as mentioned previously, a similar advantage is preferably attained.

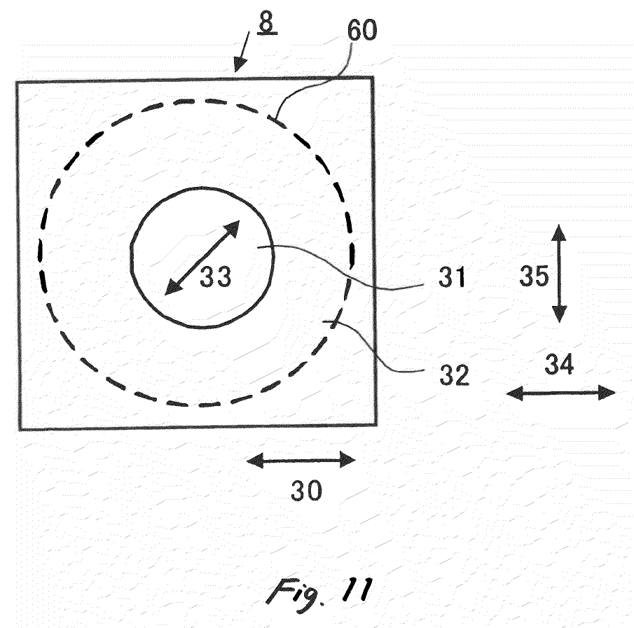

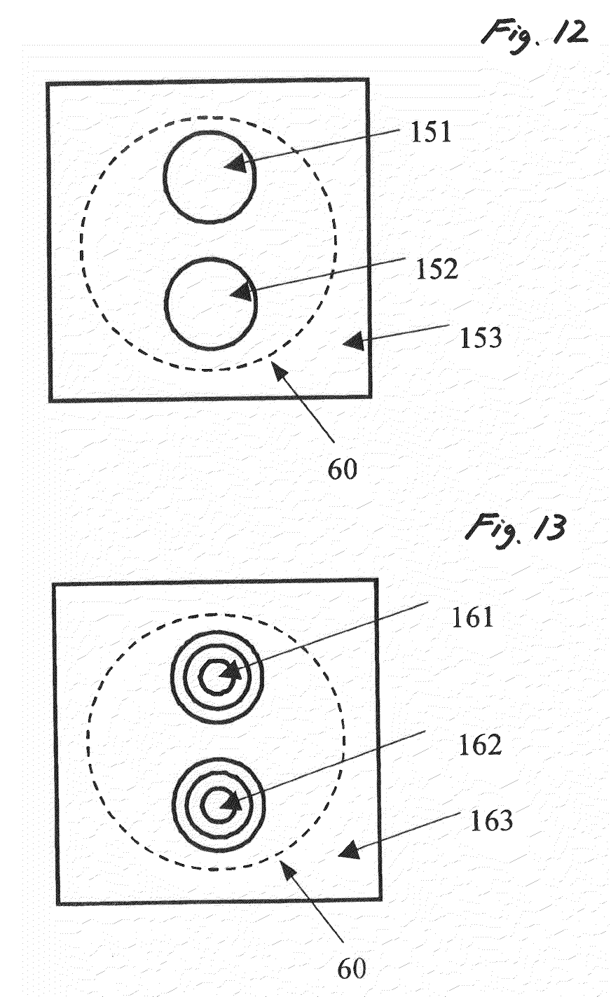

A third embodiment of the depolarizing element 8 has a structure in which a birefringent layer located within an incident light flux 60 where light from the light source is incident on is made up of a plurality of areas and directions of optic axes of a birefringent material within the respective areas are radial. As shown in a plan view of FIG. 10(a), in the depolarizing element 8 of the present embodiment, the birefringent layer located within the incident light flux where light from the light source is incident is divided into a plurality of regular hexagonal areas arranged in a honeycomb pattern. As shown in FIG. 10(b) that shows in an enlarged manner the adjacent regular hexagonal areas, directions of optic axes designated by arrows are radial with respect to the centers of the respective areas, and a phase difference among birefringent mediums is set to one-half of the wavelength λ of the incident light. Specifically, the depolarizing element of the present embodiment has a structure where a birefringent layer located within the incident light flux on the depolarizing element 8 of the second embodiment where the directions of the optic axes are made radial (hereinafter called “radial optic-axis area”) is formed in numbers within the incident light flux of the birefringent layer. In relation to adjacent radial optic-axis areas, a distance between the centers of adjacent areas is set to 30 μm to 3 mm. The distance between the centers of the areas is preferably 50 μm or more in order to prevent occurrence of a loss in light quantity due to scattered light.

Alternatively, the depolarizing element may be configured such that a birefringent layer located within the incident light flux 60 where light from the light source falls is divided as in the case of the depolarizing element 8 of the third embodiment shown in FIGS. 10(a) and 10(b). Here, birefringent layers in respective areas are configured such that the direction of the optic axis and the magnitude of a phase difference are constant and that either or both the direction of the optic axis and the magnitude of the phase difference change from one area to another. The shape, layout, and size of the areas and the phase difference, which are achieved in the depolarizing element of the embodiment, are analogous to those achieved in the third embodiment.

In the case of the second embodiment including a single radial optic-axis area, when the center of an incident polarized light flux coincides with the center of the depolarizing element, the degree of polarization V of outgoing light comes to zero. However, when the incident light flux is decentered, there is a potential risk of the degree of polarization V of outgoing light being not sufficiently reduced. In contrast, the depolarizing element 8 of the present embodiment is less dependent on the position where an incident light flux falls, and the degree of polarization V of outgoing light is maintained at a low value even when the incident light flux is decentered. As a result, when the depolarizing element is used in the optical head device 100 shown in FIG. 1, the degree of polarization of outgoing light is maintained at a low level with regard to the sub-beam, among the three beams generated by the diffracting element 2, that is incident on, while being decentered, the depolarizing element 8, whereby fluctuations in interferential light generated from the converged light spots 15 and 17 on the light receiving surface of the photo detector 9 and the converged light spot 18 in a defocused state are effectively diminished, whereby superior reading and writing characteristics for an optical disk are implemented. In order to suppress fluctuations in the degree of polarization of outgoing light with respect to the incident position of a light flux, it is preferable that two or more radial optic-axis areas situate within the incident light flux.

The shape of the radial optic-axis area may also be an equilateral triangle or a square as well as the regular hexagon shown in FIGS. 10(a) and 10(b). Even when the directions of the optic axes of the birefringent material layer achieved in the radial optic-axis areas are arrange in a concentric pattern instead of the radial pattern as mentioned above, a similar advantage is preferably attained.

As shown in FIG. 11, in a fourth embodiment of the depolarizing element 8, the birefringent layer located within the incident light flux 60 where light from the light source is incident has a first area 31 and a second area 32. The area 31 includes a birefringent medium exhibiting a birefringent characteristic, and the directions of optic axes denoted by the arrows 33 form an angle of 45 degrees with the direction of polarization of incident light denoted by an arrow 30, and the magnitude of a phase difference is set to an odd multiple of one-half of the wavelength λ of light from the light source. The area 31 is configured so as not to exhibit a phase difference.

When the linearly-polarized light achieved in the foregoing direction of polarization; namely, incident light whose degree of polarization V is substantially one, falls on the depolarizing element 8 of the present embodiment, light beams transmitted through the areas 31 and 32 of the depolarizing element 8 becomes linearly-polarized light beams that are orthogonal to each other as indicated by arrows 34 and 35 shown in the drawing. In the light flux transmitted through the depolarizing element 8, light fluxes whose polarized states differ from each other depending on locations where the fluxes transmit are superimposed on each other, and hence the degree of polarization V decreases. For instance, when quantities of light transmitting through the areas 31 and 32 are in the proportion of 3:1, the degree of polarization V comes to 0.5. When quantities of light transmitting through the areas 31 and 32 are in the proportion of 1:1, the degree of polarization V preferably comes to zero.

In order to simplify the explanations, the shape of the area 31 is expressed as a circle, and the number of areas shown is 2 in FIG. 11. However, the present invention is not limited to the exemplified shape and the exemplified number of areas.

The shape of the area 31 can also be embodied as a shape that is similar to or envelops the shape of the light receiving areas 11, 12, and 13 of the photo detector 9 shown in FIG. 2, for instance. Polarization of the light arriving at the light receiving areas 11, 12, and 13, among light beams forming the converged light spot 18 of stray light radiated onto the light receiving areas 11, 12, and 13, can also be taken as; for instance, a direction of polarization along the direction of arrow 34 shown in FIG. 11. With the above configuration, the light that originates from the recording surface of the optical disk to be subjected to reading and writing and that forms the converged light spots 15, 16, and 17 shown in FIG. 2 is converged as a light flux transmitted through a plurality of areas, such as the areas 31 and 32 shown in FIG. 11. As a result, the degree of polarization V of the light transmitted through the depolarizing element 8 is reduced, and interference arising between the main beam and stray light is preferably reduced.

As shown in FIG. 12, a fifth embodiment of the depolarizing element 8 has divided areas 151, 152, and 153. The areas 151 and 152 are arranged symmetrically about the optic axis of the depolarizing element 8. The areas 151 and 152 is made substantially equal to each other in terms of a phase difference. The phase difference of the areas 151 and 152 and a phase difference of the area 153 are preferably made to an odd multiple of one-half of the wavelength λ of incident light.

In a configuration preferably illustrated as such a configuration, the phase difference of the areas 151 and 152 is set to one-half the wavelength λ of incident light, and directions of optic axes of the areas are set so as to form an angle of 45 degrees with the direction of polarization of linearly-polarized light, and the phase difference of the area 153 is set to zero. With the above configuration, light transmitted through the areas 151 and 152 turns into linearly-polarized light whose direction of polarization is orthogonal to incident light, and light transmitted through the area 153 does not change in terms of a polarized state and hence has the direction of polarization orthogonal to the light transmitted through the areas 151 and 152. Therefore, as in the case of a sixth embodiment, it is possible to reduce the degree of polarization V of the transmitted light by appropriately setting quantities of light transmitting through the respective areas.

The light transmitted through the areas 151 and 152 is substantially orthogonal to the light transmitted through the area 153 in terms of the direction of polarization. Accordingly, when the depolarizing element 8 of the present embodiment is used with the optical head device 100 shown in FIG. 1, return light of the sub-beam from the one layer, in which the light transmitted through the area 153 of a wide area becomes predominant, and stray light from another layer transmitted through the areas 151 and 152 enter, while being in greatly-different polarized states, the light receiving areas 11 and 13 of the photo detector 18, whereupon a reduction in interference and crosstalk is preferably attained.

The polarization diffracting element of the embodiment shown in FIG. 13 is another example of the fifth embodiment and configured in such a way that a phase difference continually or stepwise changes in a boundary between areas 161 and 162 corresponding to the areas 151 and 152 of the polarization diffracting element shown in FIG. 12 and a area 163 corresponding to the area 153 in the polarization diffracting element shown in FIG. 12. By such a configuration, the diffraction arising in a boundary between the areas can be reduced, and hence a mixture of polarization, which results from a stray light component of another layer transmitted through the area 163 being mixed in the light receiving areas 11 and 13 by a diffraction phenomenon in the boundary between the areas, can be diminished. As a result, a great difference in polarized state between return light from the one layer and return light from another layer is achieved, and considerable improvement in crosstalk is attained.

When the depolarizing element of the present embodiment is used, there is attained an advantage of a reduction arising in crosstalk of an optical head device for a multi-layer optical disk using various tracking techniques. In particular, when the depolarizing element is used for a technique, such as a three-beam technique and a DPP technique in which a tracking error is detected by use of light separated into three beams by the diffraction grating 2, a considerable effect for reducing crosstalk is attained.

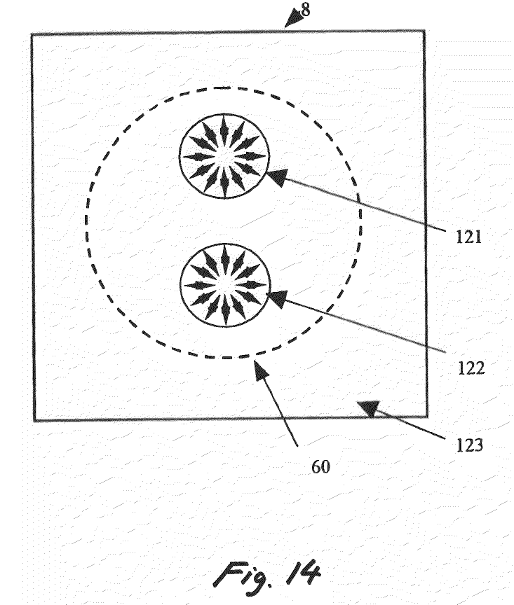

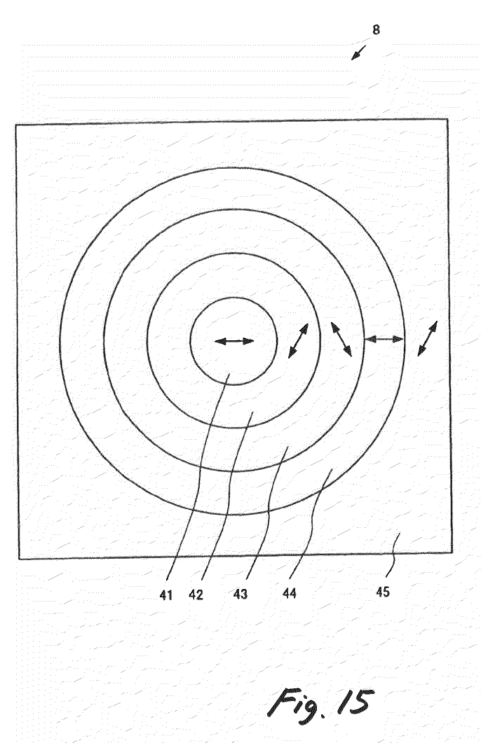

As shown in FIG. 14, a still another example of the depolarizing element 8 according to the fifth embodiment has divided areas 121, 122, and 123. The areas 121 and 122 are arranged symmetrically about the optic axis of the depolarizing element 8. In the areas 121 and 122, the direction of optic axes are radial with respect to the optical axis, as in the second embodiment shown in FIG. 9(a). A phase difference of the birefringent medium is set to an odd multiple of one-half of the wavelength λ of incident light. In the areas 121 and 122, the direction of the optic axis may also be arranged in a concentric pattern instead of the foregoing radial pattern. Further, there may also be adopted a configuration similar to; for example, those shown in FIGS. 5(a), 5(b), 7(a) and 7(b), in which the areas 121 and 122 are further radially divided and in which polarized states of transmitted light beams from respective further-divided sub-areas exhibit 90-degree rotational symmetry.

It is preferable to design the position, size, and shape of the areas 121 and 122 in the depolarizing element 8 of the present embodiment in such a way that, when the depolarizing element is used in the optical head device 100 that reads and writes information with respect to a multi-layer optical disk, return light from another layer transmitted through the areas 121 and 122 reaches the light receiving areas 11 and 13 for sub-beams on the photo detector in FIG. 2. As a result of the depolarizing element being configured as mentioned above, the degree of polarization of return light from another layer in the light receiving areas for sub-beams can be reduced, so that a sub-beam detection characteristic especially vulnerable to crosstalk can be enhanced.

When the depolarizing element 8 of the present embodiment is used for the optical head device 100 that reads and writes information with respect to a multi-layer optical disk, the return light from the one layer transmits through the areas 121, 122, and 123 of the depolarizing element 8, and light transmitted through the area 123 having a large area becomes predominant. For this reason, it is preferable to design the direction of the optic axis and the magnitude of a phase difference, which are achieved in the area 123, in such a way that interference arising between the return light transmitted through the area 123 and the previously-described return light transmitted through the areas 121 and 122 is diminished.

Specifically, the area 123 may also be made analogous to the fourth embodiment shown in FIG. 9(a) in which the direction of the optic axis is radial with respect to the optical axis and in which the phase difference of the birefringent medium is set to λ/2 when the wavelength of incident light is taken as λ. Alternatively, the area 123 may also be configured such that the area is further divided and that a polarized state changes from one sub-area to another. Moreover, the area may also be configured so as to exhibit no phase difference or exhibit a constant phase difference and a constant direction of an optic axis. In any one of the cases, interference arising between the return light from the one layer and the return light from another layer achieved on the photo detector is diminished, so that crosstalk can be enhanced.

As shown in FIG. 15, the sixth embodiment of the depolarizing element 8 has concentrically-divided areas 41 to 45, and polarized states of light transmitted through the respective areas 41 to 45 are arranged along; for instance, directions of arrows shown in the drawing. There is achieved a polarized state in which directions of linearly-polarized light achieved in adjacent areas differ from each other by about 60 degrees. Magnitudes of phase differences achieved in the respective areas 41 to 45 are preferably set to an odd multiple of one-half of the wavelength λ of incident light and, more preferably, one-half times the wavelength.

When the polarized states of; for example, the areas 41 and 42 are expressed by normalized Stokes parameters (S₀₀, S₁₀, S₂₀, S₃₀), and (S₀₁, S₁₁, S₂₁, S₃₁), the respective states can be expressed as (1, 1, 0, 0) and (1, −0.5, 0.866, 0). A difference between the polarized states achieved in these areas is evaluated by y which is represented by (S₁₀−S₁₁)²+(S₂₀−S₂₁)²+(S₃₀−S₃₁)², the following equation is obtained:

γ=(1+0.5)²+(0−0.866)²+(0−0)²=3 (15)

Consequently, in a ninth embodiment of the depolarizing element 8, provided that there is γ=3, diffraction attributable to a difference between polarized states of divided areas can be preferably reduced.

The present invention is not limited to the depolarizing element 8 according to the previously-described embodiments. For instance, the method for forming divided areas of a birefringent medium can also be embodied in various patterns; for instance, a stripe pattern, a checkered pattern, and the like. Moreover, either a phase difference or an optic axis, or both of them, can also be changed from one area to another. Further, even when the phase difference or the direction of an optic axis is continually changed, a pattern for continually changing them within a plane is not limited to that exemplified in FIGS. 9(a) and 9(b).

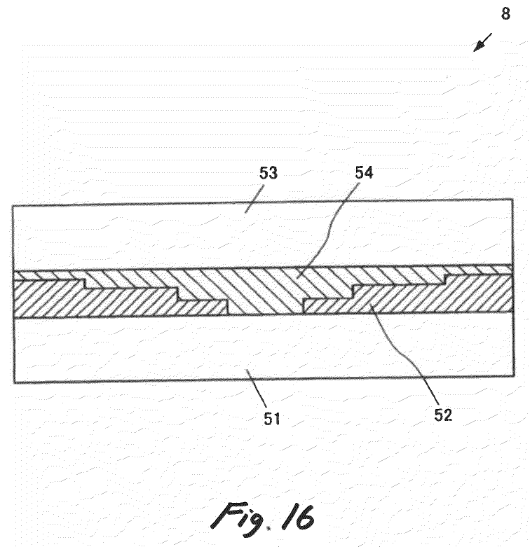

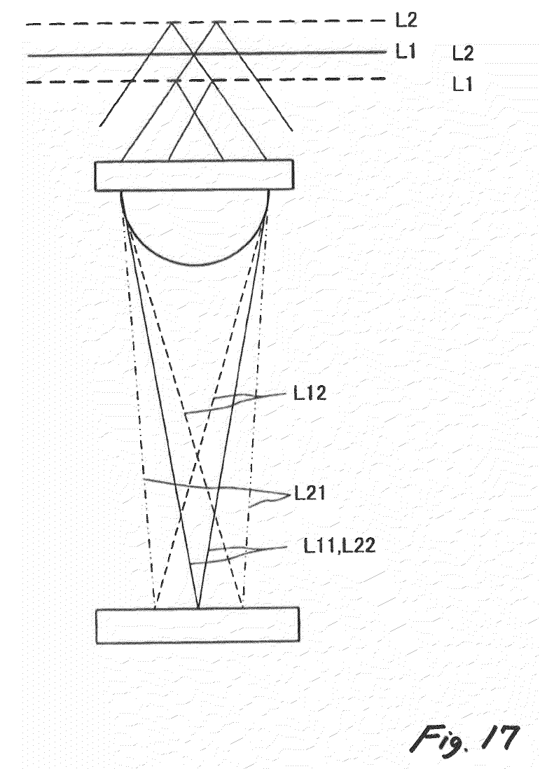

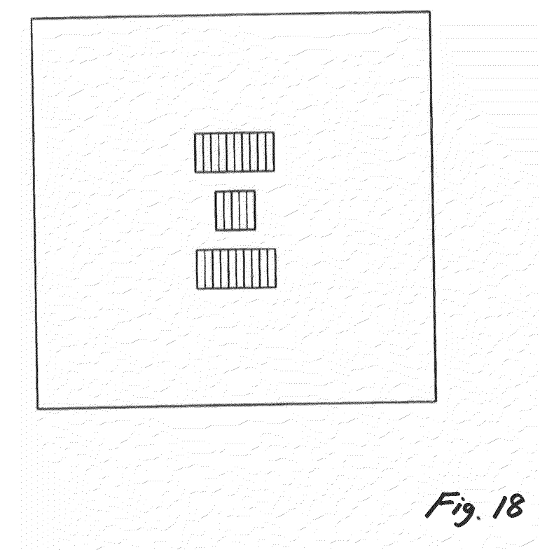

The variation of magnitude of a phase difference can be created by a method for providing the variation in the thicknesswise direction of a birefringent medium layer or a method for making the thickness of the birefringent medium layer uniform and changing the direction of the optic axis with respect to the surface of a substrate. The method for providing the variation of a phase difference by use of polymer liquid crystal as a birefringent medium layer will be described by reference to FIG. 16 that shows a seventh embodiment of the depolarizing element 8. FIG. 16 is a schematic section view of a structure in which the birefringent medium layer of the depolarizing element 8 exhibiting a concentric distribution of a phase difference increasing from the center of the element to the outer periphery of the same is formed with polymer liquid crystal. Application of the present technique is not limited to the case of such a concentric distribution.

The depolarizing element 8 shown in FIG. 16 has a first transparent substrate 51; a polymer liquid crystal layer 52 exhibiting the variation of thickness in the radial direction within the surface of the element; a second transparent substrate 53; and a transparent medium layer 54 sandwiched between the first substrate 51 and the second substrate 53. The depolarizing element also has concentric areas where the magnitude of a phase difference change.

The thickness of the polymer liquid crystal layer 52 can be made in the form of a desired variation by; for instance, photolithography or etching. Further, the thickness of the polymer liquid crystal layer 52 can also be set by providing the first substrate 51 with predetermined concavities and convexities. Use of a substrate made from; for example, transparent glass or plastic, as the first and second substrates 51 and 53 is preferable.

An entire space between the first substrate 51 and the second substrate 53, including a thin portion of the polymer liquid crystal layer 54 exhibiting the variation of a thickness, is filled with a transparent medium layer 54. The transparent medium layer 54 is made from a transparent material having a refractive index that is equal to either an ordinary refractive index no or an extraordinary refractive index nₑ of the polymer liquid crystal layer 52 or that is between the ordinary refractive index no and the extraordinary refractive index nₑ of the polymer liquid crystal layer 52. Such a transparent material layer 54 can be formed by filling the space between the transparent substrates 51 and 53 with a filler formed from; for instance, an isotropic material, so as to fill a recess of the polymer liquid crystal layer 52.

The refractive index “n” of the transparent medium layer 54 is caused to coincide with either the ordinary refractive index no or the extraordinary refractive index nₑ of the polymer liquid crystal layer 52 or set to an average value (nₒ+nₑ)/2 of the ordinary refractive index no and the extraordinary refractive index nₑ, thereby preventing disturbance of a wave front of the transmitted light in a more preferred manner.

There will now be described a method for making the thickness of the birefringent layer uniform, and changing the direction of an optic axis with respect to the surface of the substrate. The direction of an optic axis with respect to the surface of the substrate can be determined by varying a tilt angle of the polymer liquid crystal layer within an element surface. The tilt angle refers to an angle formed by major axes of liquid crystal molecules of the polymer liquid crystal layer 52 with the surface of the substrate. For instance, provided that the tilt angle is set nearly to 90 degrees; namely, liquid crystal molecules are made approximately perpendicular to the substrate 51, while the thickness of the birefringent medium layer is made constant, an amount Δn of birefringence is reduced, to thus enable a reduction in phase difference. When the tilt angle is made close to zero degree; namely, when the liquid crystal molecules are made nearly parallel to the substrate surface, the amount Δn of birefringence is increased, thereby increasing a phase difference.

A method for controlling the direction of an optic axis will now be described. When the polymer liquid crystal layer 52 is used as a birefringent layer, the direction of an optic axis can be controlled by use of a technique for rubbing an alignment layer determining the orientation of a liquid crystal against a desired direction (e.g., a concentric pattern) or a method for controlling the orientation by use of a material that subjects an alignment layer to optical orientation.

When a plurality of minute irregular grooves conforming to a desired distribution of orientations of optic axes are formed in the substrate surface contacting the polymer liquid crystal layer 52, liquid crystal molecules can be oriented in the longitudinal direction of the irregular grooves. Such a method is particularly suitable for the case where the depolarizing element 8 whose orientation of optic axis continually changes as shown in FIG. 9 is fabricated.

The depolarizing element of the present invention is not limited to the case where incident light corresponds to linearly-polarized light but can also be effectively used, so long as the incident light is polarized light. Specifically, the polarization diffracting element of the present invention can be preferably used for circularly-polarized light or elliptically-polarized light as in the case of linearly-polarized light.

As mentioned above, according to the optical head device 100 of the present embodiment, there is adopted a structure in which the depolarizing element 8 that decreases the degree of polarization of transmitting light is placed at an optical path between the beam splitter 4 and the photo detector 9. Hence, the degree of polarization of return light beams from respective layers can be decreased on the photo detector 9 exposed to the return light beams from the respective layers of a multi-layer disk, and interference of the light beams can be diminished.

Therefore, the optical head device 100 of the present embodiment can prevent occurrence of a deterioration in reading performance, which would otherwise be caused by a variation in a signal intensity due to a change in conditions for interference of light from a different layer attributable to a change in an interval between layers of a multi-layer disk and a change in a wavelength. Accordingly, a multi-layer disk can be subjected to writing or reading without involvement of a decrease in the intensity of a signal to the photo detector 9.

Although the present invention has been described in detail by reference to the specific embodiment, it is manifest to those skilled in the art that the present invention is susceptible to various alterations or modifications without departing from the spirit and scope of the present invention.

The present invention is based on Japanese Patent Application (JP-A-2006-072671) filed on Mar. 16, 2006 in Japan, contents of which are incorporated herein by reference.

### INDUSTRIAL APPLICABILITY

As mentioned above, the optical head device of the present invention is useful as an optical head device, or the like, that attains an advantage of the ability to perform reading or writing with respect to a multi-layer optical disk without involvement of a decrease in the intensity of a signal to a photo detector.

1. An optical head device, comprising:
a light source;
an objective lens, configured to converge light emitted from the light source to an information recording surface of an optical disk;
a beam splitter, configured to deflect returned light reflected by the optical disk into an optical path which is different from an optical path of the light emitted from the light source;
a photo detector, configured to detect the returned light deflected by the beam splitter; and
a depolarizing element, disposed on an optical path between the beam splitter and the photo detector, and configured to cause the returned light to transmit through while reducing a degree of polarization of the returned light.

2. The optical head device as set forth in claim 1, wherein:
the depolarizing element has a birefringent layer comprised of a birefringent material; and
at least one of a phase difference and an optic axis is different in accordance with a position on a surface of the depolarizing element, so that a polarized state of the returned light transmitted through the depolarizing element is changed in accordance with a position on the surface of the depolarizing element on which the returned light is incident.

3. The optical head device as set forth in claim 1, wherein:
the depolarizing element is configured such that the degree of polarization of the returned light is made to be 0.5 or less.

4. The optical head device as set forth in claim 2, wherein:
a region of the birefringent layer to be situated within a light flux of the light incident on the depolarizing element is divided into a plurality of areas such that polarized states of light transmitting through adjacent ones of the areas are made different from each other.

5. The optical head device as set forth in claim 4, wherein the region is radially divided so that the areas are arranged around an optical axis of the optical path as a center, such that the polarized states of light transmitting through the areas become identical at a cycle of 360/j degrees in a circumferential direction as to the optical axis (j is an integer of 2 or more).

6. The optical head device as set forth in claim 4, wherein:
the region is divided so that the areas are arranged concentrically with an optical axis of the optical path as a center.

7. The optical head device as set forth in claim 4, wherein:
a relationship (1) is satisfied when the polarized states of the light transmitting through the adjacent ones of the areas are respectively represented as (1, S₁₀, S₂₀, S₃₀) and (1, S₁₁, S₂₁, S₃₁) by using a normalized Stokes parameter (S₀ₖ=1, S₁ₖ, S₂ₖ, S₃ₖ):
0<(S₁₀−S₁₁)²+(S₂₀−S₂₁)²+(S₃₀−S₃₁)²≦3 (1).

8. The optical head device as set forth in claim 4, wherein:
a relationship (2) is satisfied when the polarized states of the light transmitting through ones of the areas which are shifted from each other by approximately 90 degrees in a circumferential direction as to the optical axis are respectively represented as (1, S₁₃, S₂₃, S₃₃) and (1, S₁₄, S₂₄, S₃₄) by using a normalized Stokes parameter (S₀ₖ=1, S₁ₖ, S₂ₖ, S₃ₖ):
2≦(S₁₃−S₁₄)²+(S₂₃−S₂₄)²+(S₃₃−S₃₄)²≦4 (2).

9. The optical head device as set forth in claim 4, wherein:
an interval between centers of the areas falls within a range from 30 μm to 3 mm; and
optic axes in each of the areas are directed radially or concentrically.

10. The optical head device as set forth in claim 4, wherein:
the phase difference in the birefringent layer is constant; and
the optic axis of the birefringent layer is directed radially or concentrically with respect to an optical axis of the optical path as a center.

11. The optical head device as set forth in claim 4, wherein:
a phase difference of the birefringent layer is an odd multiple of one-half of a wavelength of the returned light incident on the depolarizing element.

12. The optical head device as set forth in claim 5, wherein:
the birefringent layer is divided into 4 areas each of which has an area corresponding to 90 degrees in the circumferential direction of the birefringent layer; and
optic axes of adjacent ones of the areas are angled by 90 degrees from each other, and angled by 45 degrees from a polarized direction of the returned light incident on the depolarizing element.

13. The optical head device as set forth in claim 4, wherein:
the region is divided into a first area arranged concentrically with an optical axis of the optical path, and a second area which is an area other than the first area.

14. The optical head device as set forth in claim 4, wherein:
the region is divided into a first area and a second area which are arranged symmetrically with an optical axis of the optical path, and a third area which is an area other than the first area and the second area.
